(19) United States
(12) Patent Application Publication
(10) Pub. No.: US 2010/0005024 A1
(43) Pub. Date: Jan. 7, 2010

(54) System and Method for Enrolling Individuals in an Automated Payment Plan

(76) Inventors: Brian SCHMITZ, San Francisco, CA (US); John BRINNON, Pleasanton, CA (US)

Correspondence Address: AFS/ VISA, 666 THIRD AVENUE , 10TH FLOOR, NEW YORK, NY, 10017, US

(21) Appl. No.: 12/497,191

(22) Filed: Jul. 2, 2009

Related U.S. Application Data
(60) Provisional application No. 61/077,813, filed on Jul. 2, 2008.

(51) Int. Cl. G06Q 40/00

(52) U.S. Cl. 705/40

(57) ABSTRACT

A system and method for enrolling check-writing customers in an automated payment program for paying recurring bills from a merchant with a financial presentation device (FPD) such as a debit or credit card instead of a check. An enrollment module receives a list of target customers that pay recurring bills by paper checks. An enrollment form is then sent out to the targeted customers. The enrollment form preferably requires minimal effort by the customer, for instance, requiring only a signature. Responsive to the enrollment forms that have been returned by the targeted customers which signify their desire to enroll in the automated payment program, the enrollment module receives a list of such customers. Based on the received list of customers, the enrollment module generates enrollment information which is sufficient to enable the merchant to enroll the customers in the automated payment program.

### CROSS-REFERENCE TO RELATED APPLICATIONS

This application claims the benefit of priority under 35 U.S.C. §119 to commonly owned and assigned U.S. provisional patent application Ser. No. 61/077,813 on Jul. 2, 2008 and entitled “System And Method For Enrolling Individuals In An Automated Payment Plan”, which is incorporated by reference herein in its entirety.

### FIELD OF THE INVENTION

The present invention relates to a system and method of enrolling a customer in an automated payment program, and more particularly relates to a system and method of enrolling check-writing customers in an automated payment program for paying bills from merchants with a financial presentation device instead of a check.

### BACKGROUND OF THE INVENTION

Despite the convenience and other benefits associated with payment for goods and services by credit and debit cards, many individuals and businesses still rely on conventional checks to pay invoices for services and goods. This creates inefficiencies for the check-writer, as they typically must write and mail a check for each invoice, and keep track of these checks on an individual basis.

In addition, various financial institutions are involved in processing these checks, including transferring the check from the payee to the check-writer's bank, and transferring funds from the check-writer's bank to the payee's bank. Traditional check processing involves expenses associated with personnel, equipment and software, transit and facilities, often averaging several dollars per check.

Further, the merchants must often wait for the check to clear before the funds are available. In addition, besides waiting for the check to clear once it is received, other inconveniences include the ubiquitous “the check is in the mail” excuse.

Accordingly, various entities including banks and merchants have incentives to induce check-writers to migrate to the more efficient electronic methods, particularly for periodic payments, to avoid the expensive processing of hand written checks.

It would therefore be desirable to provide a system and method that encourages check-writers to convert to bill payment using a financial presentation device such as a credit or debit card.

### SUMMARY OF THE DISCLOSURE

The present invention provides a system and method for enrolling check-writing customers in an automated payment program for paying recurring bills from a merchant with a financial presentation device (FPD) instead of a check. Indications are received from a portion of customers that pay recurring bills by paper checks are identified. Indications are received from a portion of the identified customers of a desire to enroll in the automated payment program for paying the recurring bills with FPDs instead of the paper checks. Enrollment information is generated and stored based on the received indications for submission to one or more participating merchants. The enrollment information can include customer identifiers for the customers that have indicated their desire to enroll so as to enable the merchant(s) to enroll the customers in the automated payment program.

The purpose of this invention is to encourage individuals (customers) who currently pay bills using paper checks to enroll in an automated payment program in which their bills, such as recurring bills including but not limited to television service, telephone service, utilities, and other recurring bills, are paid automatically using an FPD rather than checks. In aspect, the inventive system and method involves partnering with the issuing financial institutions to identify the check-writing customers, offering to enroll the customers in a simple manner without the customers having to take any further steps beyond indicating their approval, and arranging with merchants to set up automatic payments for the enrolled customers.

The process is very convenient from the customer's point of view. For instance, they receive an offer to enroll from the issuer bank (e.g., in a monthly credit card bill), and if they indicate an approval (by checking a box, calling a service center, etc.), they do not need to take further steps, as either the issuer or Visa will contact the participating merchants.

In another aspect, the present invention provides a system and method for enrolling check-writing customers in an automated payment program for paying recurring bills from a merchant with an FPD instead of a check. Identification data, of a plurality of customers that pay recurring bills by paper checks and that also hold at least one FPD, is received and stored. Indications are received from a portion of the identified customers of a desire to enroll in the automated payment program for paying the recurring bills with FPDs instead of the paper checks. Based on the received indications, enrollment information is generated and stored for submission to participating merchants. The enrollment information includes customer identifiers and FPD identifiers for the customers that have indicated the desire to enroll so as to enable the merchant to enroll the customers in the automated payment program.

### BRIEF DESCRIPTION OF THE DRAWINGS

FIGS. 1A and 1B schematically depict entity relationships according to embodiments of the present invention;

FIG. 2 is a block diagram a computer operating an identification module according to an embodiment of the present invention;

FIG. 3 is a block diagram a computer operating an enrollment module according to an embodiment of the present invention;

FIGS. 4-5 are process flow diagrams of identification of check-writing customs according to certain embodiments of the present invention; and

FIG. 6 is a process flow diagram of enrollment of customers in the automatic payment program according to an embodiment of the present invention.

### DETAILED DESCRIPTION OF THE INVENTION

As used herein, a financial presentation device (FPD) is a device that can be presented to sellers of goods or services for payment, and includes, but are not limited to, credit cards, debit cards, prepaid cards, electronic benefit cards, charge cards, virtual cards, smart cards, key chain devices, personal digital assistants, cell phones, stored value devices and the like.

Further, as used herein, “transaction processing facilitator” is a network such as VISA®, MasterCard®, American Express®, Discover® (and others) that acts as a switch between acquirers and issuers for routing messages therebetween for purposes of authorization, clearing and/or settlement of financial transactions by customers with merchants.

In addition, as used herein, “automatic payment program” is any program established by an entity that allows a customer to preauthorize payments for goods and/or services from the merchant, in which the payment is made by a withdrawal or charge to an account of the customer's choice. The entity establishing the automatic payment program can be a merchant, coalition of merchants, third party on behalf of a merchant, bank, or independent party (e.g., CheckFree®, MyCheckFree®, Billeo®).

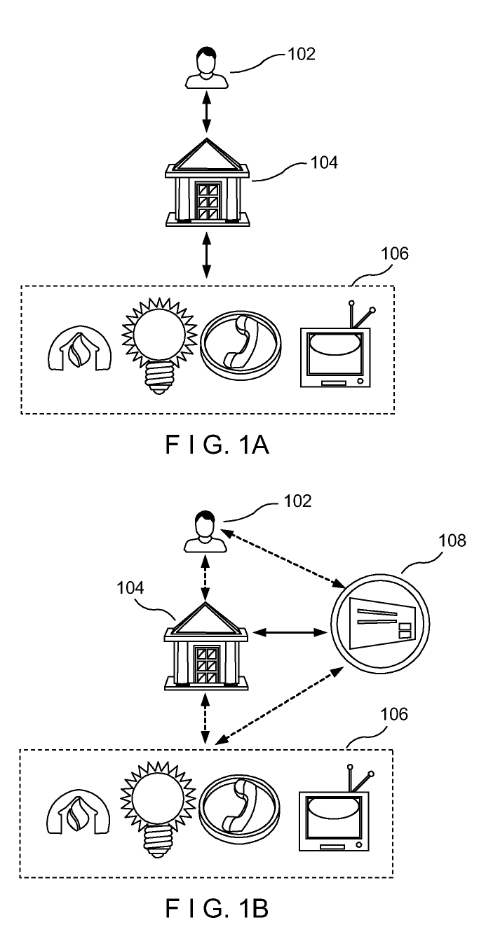

Referring to FIG. 1A, the relationships between entities for enrollment in one or more automatic payment programs according to the present system and method are depicted. A customer 102 has a relationship with an issuing financial institution 104, such as a bank extending a line of credit to the customer 102 for credit cards, or maintaining a bank account associated with a debit card. The issuing financial institution 104, in turn, facilitates enrollment of the customer 102 in one or more automatic payment programs offered by merchants 106. Merchants 106 generally include, but are not limited to merchants having recurring bills such as utility companies, land-line telephone service providers, mobile telephone service providers, television service providers, internet service providers, maintenance companies, insurance companies, mortgage banks, automobile financing companies, and other merchants with periodic (e.g., weekly, semi-monthly, monthly, bimonthly, quarterly, semi-annually, or annually). In additional embodiments, the merchants can also be businesses that provide non-periodic services to customers, but have an established bill payment program.

FIG. 1B shows entity relationships for automatic enrollment according to the present system and method similar to that of FIG. 1A, with the inclusion of a transaction processing facilitator 108 such as VISA® or MASTERCARD®. In general, the transaction processing facilitator 108 communicates with the issuing financial institution 104 to facilitate automatic enrollment in one or more bill payment programs. In addition, the transaction processing facilitator 108 can communicate with customers and/or merchants, in conjunction with or as an alternative to communications from and to the issuing financial institution 104.

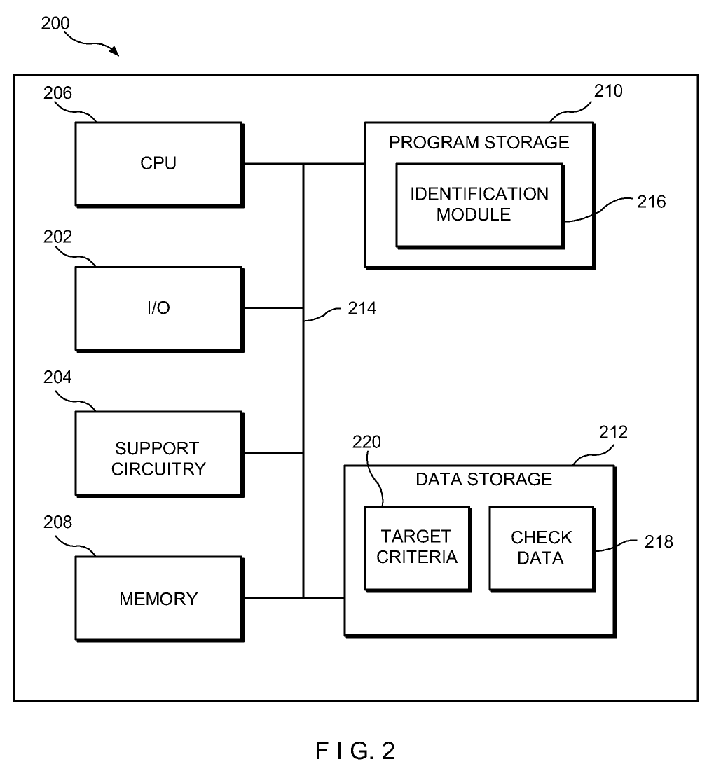

An exemplary computer 200 in which the identification module 214 of the present invention can be implemented is shown in FIG. 2. Computer 200 includes a processor 206, such as a central processing unit, an input/output interface 202, and support circuitry 204. The processor 206, input/output interface 202, and support circuitry 204 are commonly connected to a bus 214, which is also connected to a memory storage 208, program storage 210 and data storage 212.

Program storage 210 stores software program modules including but not limited to modules to identify check-writing account holders for the present system and method, and in particular stores the software code used for the identification module 214. The computer 200 generally supports an operating system stored in program storage memory 210 and executed by the processor 206 from volatile memory, e.g., memory 208. In certain embodiments of the present invention, one or more handwriting recognition software modules can also be incorporated in program storage memory 210. Data storage memory 212 stores data including but not limited to check data 218, and optionally target criteria 220.

Check data 218 can include account holder's names, contact information (e.g., address, telephone, facsimile, and/or email address), the account number(s), historical check data including date, amount and payee, and optionally including check images. As described further herein, in certain embodiments of the identification module, historical check data is used to identify check-writers and associated payees, in particular, payees that are recurring payees.

In certain embodiments of the present system and method, all check-writing account holders that pay bills such as recurring bills by check, e.g., customers of one or more financial institutions that pay recurring bills by paper check, can be targeted, and there is no further requirement for additional criteria.

In further embodiments, from the set of identified check-writing account holders that pay recurring bills, a subset can be further designated based on certain target criteria 220, including one or more of income level, education level, billing address, payee merchants, credit rating, whether the check-writer is also a holder of a financial presentation device issued by the same or different financial institution, or other demographics. In additional embodiments, information specific to a financial presentation device account can be included in the target criteria 220, including but not limited to the issuing financial institution, the payment history of the customer, credit line, credit rating, product type (e.g., for Visa® credit cards, product types include but are not limited to Visa® Traditional, Traditional Rewards, Signature and Signature Preferred), and the length of time the customer has had the account for the financial presentation device. In one example, targeting criteria can include check-writers that draws checks from an account held at a particular financial institution (e.g., a financial institution participating in the herein system and method), which also holds a financial presentation device issued by the same financial institution, that uses that financial presentation device for less than twelve transactions per year. In short, the targeting criteria can be tailored to select those check writers who also own a credit or debit card, but does not use the card very often.

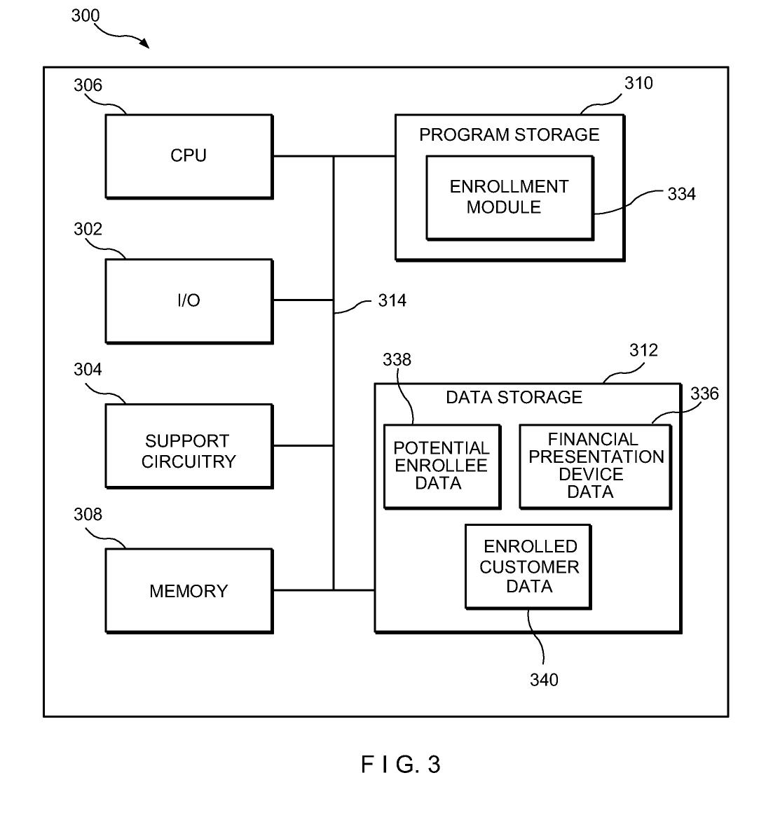

An exemplary computer 300 in which the enrollment module 334 of the present invention can be implemented is shown in FIG. 3. Computer 300 includes a processor 306, such as a central processing unit, an input/output interface 302, and support circuitry 304. The processor 306, input/output interface 302, and support circuitry 304 are commonly connected to a bus 314, which is also connected to a memory storage 308, program storage 310 and data storage 312.

Program storage 310 stores software program modules including but not limited to modules to enroll check-writing customers for the present system and method, and in particular stores the software code used for the enrollment module 334. The computer 300 generally supports an operating system stored in program storage memory 310 and executed by the processor 306 from volatile memory, e.g., memory 308. Data storage memory 312 stores data including but not limited to financial presentation device data 336, potential enrollee data 338 and enrolled customer data 340.

Financial presentation device data 336 includes, but is not limited to, card/account number, name, address, product type, expiration date, and transaction history. Potential enrollee data 338 includes identification data of a plurality of customers that pay recurring bills by paper checks, for instance, as identified by the identification module 216, or alternatively as a part of the enrollment module 334. In addition, in certain embodiments, the list of customers in potential enrollee data 338 can be derived from other sources, for instance, based on a bank's customer list (e.g., customers with active checking accounts), a merchant's listing of customers that pay by check, or any other suitable source. Enrolled customer data 340 includes a list of customers that have enrolled in the automatic payment program as described herein. The listing of enrolled customer data 340 is created and maintained to facilitate communication with the participating merchant and/or issuing financial institution, and to update the customers as to changes or updated in the automatic payment program.

It is to be appreciated by one of ordinary skill in the art that the computers 200 and 300 can each be any computer such as a personal computer, minicomputer, workstation, mainframe, or a combination thereof. While the computers 200 and 300 are shown, for illustration purposes, as single computer units, either or both of the computers 200 and 300 can comprise a group/farm of computers which can be scaled depending on the processing load and size of the data sets. It will also be understood by one of ordinary skill in the art that the modules of computers 200 and 300 can be executed by a common computer, for instance, in embodiments in which one entity performs both the identification and enrollment, separate computers 200 and 300 (as illustrated) managed by the same entity, or separate computers 200 and 300 (as illustrated) managed by different entities. Furthermore, certain aspects of the modules can operate on computers apart from computers 200 and/or 300. In additional embodiments, the system can operate using only the enrollment module in computer 300, and the identification functions, i.e., determining the identification data, can be performed by the enrollment module, or identification data can be provided by a separate source.

The entity that operates either or both computer 200 and/or 300 can be an issuing financial institution, a transaction processing facilitator, and/or a participating merchant or its acquirer. That is, the system and method of enrolling check-writing customers in an automated payment program for paying recurring bills from a merchant with a financial presentation device instead of a check can be managed by an issuing financial institution, a transaction processing facilitator, and/or a participating merchant.

For instance, an issuing financial institution can operate computer 200, utilizing its data resources with respect to check data 218, to operate the identification module 216. The issuing financial institution can also operate computer 300, utilizing its resources with respect to the financial presentation device data 336 that it maintains for its customers.

Alternatively, a transaction processing facilitator can operate one or both of computers 200 and 300. Note that the transaction processing facilitator likely will not have check data 218. In this instance, such information can be provided from appropriate financial institutions. This can be facilitated due to the existing relationships between the transaction processing facilitator and the financial institutions, particularly the issuing financial institution that has the direct relationship with the customers of interest. Further, the transaction processing facilitator can operate computer 300, in order to facilitate enrollment of customers. This can be desirable, as it is possible that certain merchants may chose not to participate in a program originating from a bank with which they have no prior relationship, but would participate in a program operated by a transaction processing facilitator due to the existence of current and/or prior relationships and the typically national and global name recognition of the transaction processing facilitator.

In further embodiments, a participating merchant, or coalition of participating merchants, can operate one or both of computers 200 and 300. The merchant can determine from received check whether the drawee financial institution is participating in the herein enrollment system and method. In addition, the merchant can operate the enrollment module 334 to send offers to potential enrollees and track enrolled customers. Financial presentation device data can be obtained from participating financial institutions, in most instances after a customer has accepted an offer of enrollment in the automatic payment program.

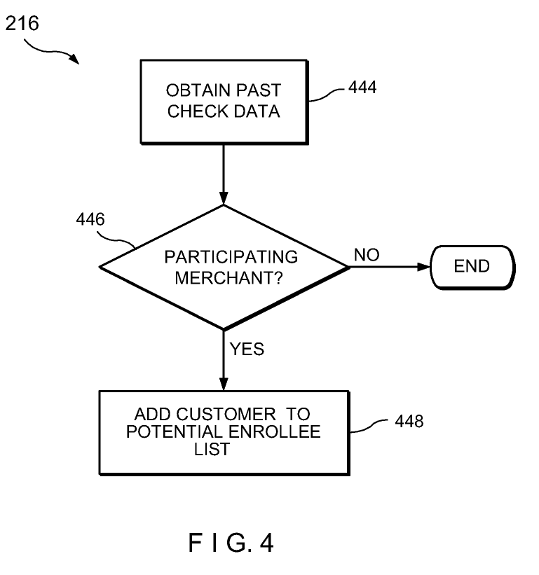

Referring to FIG. 4, an exemplary process flow for one embodiment of an identification module, e.g., identification module 216 in computer 200, is shown. An identification module 216 starts at block 444 by obtaining past check data, for instance, from check data 218. Check data for one or more checks is analyzed at block 446 to ascertain whether the payee is a participating merchant for the present enrollment system and method. If it is determined that the payee for that check is not a participating merchant, the process ends. If it is determined that the payee is a participating merchant, the check-writer is selected, as indicated at block 448, and requisite information added to the listing of potential enrollees 338. The information can include the name, contact information (e.g., mailing address, telephone number and/or email address), and financial presentation device account information. Alternatively, the financial presentation device account information can be substituted with a cross-reference to corresponding fields in financial presentation device data 336.

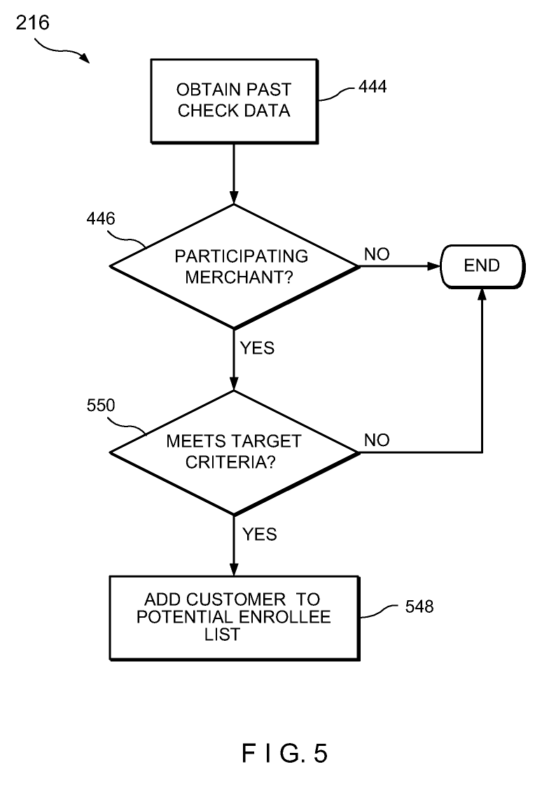

FIG. 5 shows a process similar to that of FIG. 4, further limiting the check-writers added to the list of potential enrollees 338 based on target criteria. If, at block 446, it is determined that the payee is a participating merchant, target criteria information about the identified check-writer is compared to the specified target criteria, e.g., the listing of target criteria 220. For instance, target criteria 220 can be an indication as to whether the identified check-writer holds a financial presentation device with the financial intuition participating in the system and method herein. If the check-writer is determined to meet the criteria, the check-writer is selected, as indicated at block 558, and requisite information added to the listing of potential enrollees 338.

The processes described above with respect to FIGS. 4 and 5 represent certain examples of identifying check-writers. Of course, it is also contemplated that check-writers can be identified in other ways. For instance, a participating merchant can identify check-writers to be added to the list of potential enrollees 338, based on its knowledge of the methods used by its customers to pay for goods or services. In another example, when a bank customer orders new checks, the bank, upon determining the total number of checks written over a certain time period, can inquire of customers that exceed a certain number of checks per that time period as to whether they would be interested in participating in the automatic payment program, and if so, they can be added to the list of potential enrollees 338. Inquiries can also be made to holders of financial presentation devices, for instance, in statements, paper mailings or electronic notifications (e.g., emails, or banner or pop-up advertisements on a website related to the financial presentation device) to the customers, as to whether they would be interested in participating in the automatic payment program, and if so, they can be added to the list of potential enrollees 338. Other methods of developing the list of potential enrollees 338 can also be employed.

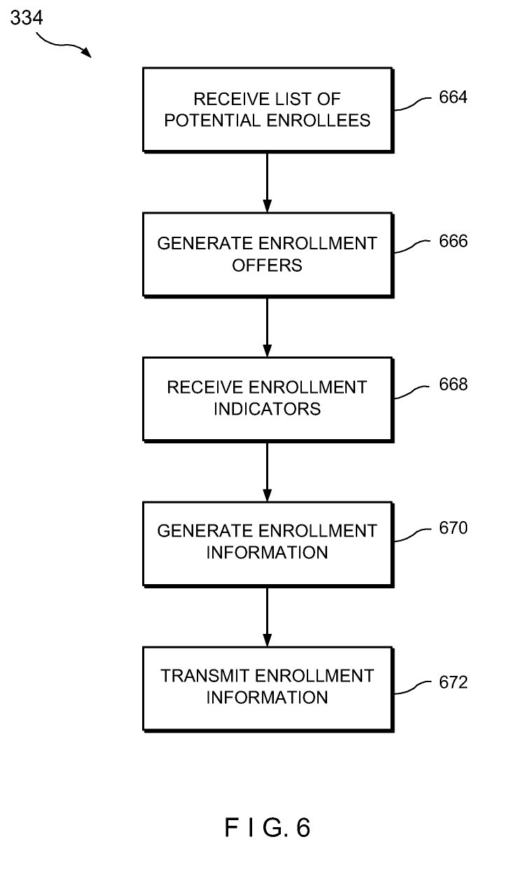

Referring now to FIG. 6, a generalized process flow of a module 334 to enroll check-writing customers according to the present system and method is shown, to be used in computer 300. Enrollment module 334 generally starts at block 664 by receiving a list of potential enrollees. The customer-potential enrollees receiving the offer can include all bank customers, or in certain embodiments, is a targets list of customers derived, for instance, from the list of potential enrollees 338 stored in data storage 312 of computer 300. As described above, this list can be created by the identification module 216, or provided by other methods. Based on this data, enrollment offers are generated as indicated at step 666. These enrollment offers are sent to the potential enrollees, and can include information about the automatic payment program, and an acceptance form to customers. The enrollment offer can be an insert or postcard in a statement from the issuing financial institution and/or an invoice from a merchant, a separate direct mailing, an email or a selection option via an online authenticated online banking or account management site.

The enrollment offer can include some indication of the financial presentation device for which the automatic payment program will be associated, e.g., the last four digits of the account, and the merchant. The enrollment offer can also include specific information about the merchant's account, for instance, all or a portion of the merchant's account number. If the merchant desires to offer any discounts to enroll in the automatic payment program, this information will also be included in the enrollment offer to entice the customer to switch their payment mode for one or more designated participating merchants from a written check to a financial presentation device using the automatic payment program. In addition, the issuing financial institution and/or the transaction processing facilitator can present offers for rewards or other benefits, e.g., additional bonus points added to their account for using the automatic payment program of the system and method herein.

In certain embodiments of the present system and method, the enrollment offer requires minimal effort on the part of the customer, for instance, requiring only a positive indication (e.g., a check mark) and/or signature on a paper form that is returned to the entity managing the acceptance aspect of the enrollment system and method, without the need for the customer to provide their account number, the merchant's account number, or other detailed information. Similarly, in certain embodiments in which the enrollment offer is presented electronically to a potential customer, clicking on an enrollment offer button will direct the potential enrollee to their online account with the bank or the transaction processing facilitator associated with the financial presentation device.

Enrollment indicators are received from the customers, indicated at block 668. If the customer accepts the offer, enrollment information is generated, indicated at block 670, and is transmitted to the necessary entity or entities, indicated at block 672. For instance, if the entity responsible for generating offers and receiving acceptances is an issuing financial institution, the issuing financial institution will notify the participating merchant that a particular customer has enrolled in the automatic payment program. This can also entail verification of the account number with the merchant to ensure that payments are credited to the appropriate account and the customer is not considered in default of any payment obligations. This information can also be included in the enrolled customer data 340. In embodiments in which the merchant is the entity responsible for generating offers and receiving acceptances, the merchant will notify the issuing financial institution of the customer's acceptance. This can also entail a request for the account number, expiration date, billing address, security code, and other requisite information about the financial presentation device, to ensure that the proper financial presentation device is charged or debited. This information can also be included in the enrolled customer data 340.

When the necessary entities have been notified, and all merchant account and financial presentation device account information has been collected, the customer is provided with a confirmation. This confirmation can include the merchant account and financial presentation device account information, and can also include opt-out instructions, the date that the automatic payment program will start, the day of each recurring period on which the financial presentation device will be charged or debited, and other information.

Note that if the customer does not return the offer, they can be retained on the list of potential enrollees, for instance, for future offers. If the customer returned the offer with a negative indication, their name and related information can be removed from the list of potential enrollees 338, for instance, particularly if the enrollment offer included a specific indicator requesting no further communications about the automatic enrollment to respect the customer's desire.

Advantageously, the present system and method provides a convenient and efficient enrollment procedure to habitual check-writers, offering this set of individuals a simple way to switch to automated payment. Advantages to the customer include the convenience of their monthly recurring bills being paid automatically, rather than the need to write checks. In circumstances in which the financial presentation device is a debit card, recurring payments can be avoided altogether if all of the merchants used by the customers are participating merchants. In circumstances in which the financial presentation device is a credit card or a charge card, the only payment required by the customer if all of the merchants used by the customers are participating merchants will be to the issuing financial institution of the financial presentation device.

In addition, the issuing financial institutions will also benefit from the system and method of automatic enrollment provided herein. A substantial portion of the requisite data for identifying check-writers can be based upon existing data. The issuing financial institutions will also receive the advantage of reduced processing costs, as the cost of processing checks is substantially greater than costs associated with fund transfers associated with financial presentation devices. In many instances, issuing banks also receive transaction fees for each debit or credit transaction.

The merchants will be ensured convenient and expeditious payment based on the automatic payment program, rather than awaiting customers checks and the necessary processing time for the funds to clear. In addition, the involvement of the transaction processing facilitator provides additional security for the merchants, as they will be accepting payment based on familiar card association brands such as, for instance, VISA®.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for enrolling check-writing customers in an automated payment program for paying recurring bills from a merchant with a financial presentation device (FPD) instead of a check, the FPD being presentable to the merchant for purchase of goods or services, the system comprising:
a memory;
a processor;
an enrollment module executable by the processor and adapted to:
receive identification data of a plurality of customers that pay recurring bills by paper checks and store the received identification data in the memory;
receive indications from a portion of the identified customers of a desire to enroll in the automated payment program for paying the recurring bills with FPDs instead of the paper checks; and
generate and store in the memory, based on the received indications, enrollment information for submission to the merchant, the enrollment information including customer identifiers for the customers that have indicated the desire to enroll so as to enable the merchant to enroll the customers in the automated payment program.

2. The system of claim 1, wherein the enrollment module identifies check-writing customers based on targeting criteria for selecting a portion of the check-writing customers.

3. The system of claim 2, wherein the enrollment module identifies check-writing customers based on past check transactions.

4. The system of claim 1, wherein the enrollment module identifies check-writing customers based on targeting criteria that selects a check-writing customer who also holds a FPD.

5. The system of claim 1, wherein the enrollment module identifies check-writing customers based on targeting criteria that selects a check-writing customer who also holds a debit or credit card.

6. The system of claim 1, further comprising an identification module executable by the processor and adapted to
identify check-writing customers based on past check transactions; and
send a list of the identified customers to the enrollment module as the identification data.

7. The system of claim 6, wherein the identification module identifies check-writing customers based on targeting criteria that selects a check-writing customer who also holds a FPD.

8. The system of claim 6, wherein the identification module identifies check-writing customers based on targeting criteria that selects a check-writing customer who also holds a debit or credit card.

9. The system of claim 1, wherein the enrollment module generates an enrollment offer for indicating the desire to enroll without requiring the customer to provide any account identification data.

10. The system of claim 1, wherein for each customer who has indicated the desire to be enrolled, the enrollment module generates a customer name, customer address and FPD account number as part of the enrollment information.

11. A system for enrolling check-writing customers in an automated payment program for paying recurring bills from a merchant with a financial presentation device (FPD) instead of a check, the FPD being presentable to the merchant for purchase of goods or services, the system comprising:
a memory;
a processor;
an enrollment module executable by the processor and adapted to:
receive identification data, of a plurality of customers that pay recurring bills by paper checks and that also hold at least one FPD, and store the received identification data in the memory;
receive indications from a portion of the identified customers of a desire to enroll in the automated payment program for paying the recurring bills with FPDs instead of the paper checks; and
generate and store in the memory, based on the received indications, enrollment information for submission to the merchant, the enrollment information including customer identifiers and FPD identifiers for the customers that have indicated the desire to enroll so as to enable the merchant to enroll the customers in the automated payment program.

12. The system of claim 11, wherein the enrollment module identifies check-writing customers based on targeting criteria for selecting a portion of the check-writing customers.

13. The system of claim 12, wherein the enrollment module identifies check-writing customers based on past check transactions.

14. The system of claim 11, wherein the enrollment module identifies check-writing customers based on targeting criteria that selects a check-writing customer who also holds a debit or credit card.

15. The system of claim 11, further comprising an identification module executable by the processor and adapted to
identify check-writing customers based on past check transactions; and
send a list of the identified customers to the enrollment module as the identification data.

16. The system of claim 15, wherein the identification module identifies check-writing customers based on targeting criteria that selects a check-writing customer who also holds a FPD.

17. The system of claim 15, wherein the identification module identifies check-writing customers based on targeting criteria that selects a check-writing customer who also holds a debit or credit card.

18. The system of claim 11, wherein the enrollment module generates an enrollment offer for indicating the desire to enroll without requiring the customer to provide any account identification data.

19. The system of claim 11, wherein for each customer who has indicated the desire to be enrolled, the enrollment module generates a customer name, customer address and FPD account number as part of the enrollment information.

20. A method of enrolling check-writing customers in an automated payment program for paying recurring bills from a merchant with a financial presentation device (FPD) instead of a check, the FPD being presentable to the merchant for purchase of goods or services, the method comprising:
receiving identification data of a plurality of customers that pay recurring bills by paper checks and storing the received identification data in a memory of a computer;
receiving, by the computer, indications from a portion of the identified customers of a desire to enroll in the automated payment program for paying the recurring bills with FPDs instead of the paper checks; and
generating by the computer, based on the received indications, enrollment information for submission to the merchant, the enrollment information including customer identifiers for the customers that have indicated the desire to enroll so as to enable the merchant to enroll the customers in the automated payment program.

21. The method of claim 20, wherein the identified customers are identified based on targeting criteria for selecting a portion of the check-writing customers.

22. The method of claim 21, wherein the identified customers are identified based on past check transactions.

23. The method of claim 20, wherein the identified customers are identified based on targeting criteria that selects a check-writing customer who also holds a FPD.

24. The method of claim 20, wherein the identified customers are identified based on targeting criteria that selects a check-writing customer who also holds a debit or credit card.

25. The method of claim 20, further comprising generating an enrollment offer for indicating the desire to enroll without requiring the customer to provide any account identification data.

26. The method of claim 20, further comprising generating a customer name, customer address and FPD account number as part of the enrollment information for each customer who has indicated the desire to be enrolled.
